(19) United States
(12) Patent Application Publication
(10) Pub. No.: US 2026/0299560 A1
(43) Pub. Date: Oct. 1, 2026

(54) DRILLING PLANT AND METHOD OF OPERATION

(71) Applicant: MHWIRTH AS, KRISTIANSAND S (NO)

(72) Inventor: ERLAND NYJORDET, GRIMSTAD (NO)

(73) Assignee: MHWIRTH AS, KRISTIANSAND S (NO)

(21) Appl. No.: 19/489,900

(22) PCT Filed: Apr. 17, 2024
(86) PCT No.: PCT/NO2024/050091

§ 371 Date: Dec. 4, 2025

(30) Foreign Application Priority Data
Jun. 6, 2023 (NO) 20230648

(51) Int. Cl. G05B 19/418; E21B 41/00

(52) U.S. Cl. CPC G05B 19/41835; E21B 41/00; G05B 2219/32128; G05B 2219/36188

(57) ABSTRACT

A drilling plant includes a plurality of machines, an operator interface with a display device, and a controller which is operatively connected to the plurality of machines and to the operator interface. The controller has a sequence operator which executes a pre-defined sequence of machine actions at the drilling plant. The controller, during the execution of the pre-defined sequence of machine actions, presents, via the display device, an operational condition to be checked by an operator, presents, via the operator interface, an interactive confirmation feature and an interactive rejection feature, waits a pre-determined time period for an input from the operator via the interactive confirmation feature or the interactive rejection feature, and, in an absence of the input from the operator and to the extent permitted, executes a next step of the pre-defined sequence of machine actions after the pre-determined time period.

### CROSS REFERENCE TO PRIOR APPLICATIONS

This application is a U.S. National Phase application under 35 U.S.C. § 371 of International Application No. PCT/NO2024/050091, filed on Apr. 17, 2024 and which claims benefit to Norwegian Patent Application No. 20230648, filed on Jun. 6, 2023. The International Application was published in English on Dec. 12, 2024 as WO 2024/253541 A1 under PCT Article 21(2).

### FIELD

The present disclosure relates to drilling plants and to methods of operating drilling plants, and in particular to plants and methods to automatically or semi-automatically execute pre-defined sequences of machine actions at the drilling plant.

### BACKGROUND

In drilling operations, it is common to carry out repeated operations of a substantially similar nature a large number of times. For example, building or dismantling a drill string may be carried out sequentially by lifting or lowering the string, and inserting or breaking out pipe sections from the string. Such operations are often carried out using highly specialized machinery, sometimes with several machines operating in tandem. Accuracy requirements can be high, and there may also be stringent requirements on health-and-safety in order to avoid personnel injury or damage to equipment.

Publications which may be useful to understand the field of technology include WO 2021/006742 A1 and WO 2020/032802 A1.

### SUMMARY

An aspect of the present invention is to automate processes within the drilling industry. Operations which are repeatedly carried out a large number of times can be suitable for automation.

In an embodiment, the present invention provides a drilling plant which includes a plurality of machines, an operator interface comprising a display device, and a controller which is operatively connected to the plurality of machines and to the operator interface. The controller comprises a sequence operator which is configured to execute a pre-defined sequence of machine actions at the drilling plant. The controller is configured, during the execution of the pre-defined sequence of machine actions, to present, via the display device, an operational condition to be checked by an operator, to present, via the operator interface, an interactive confirmation feature and an interactive rejection feature, to wait a pre-determined time period for an input from the operator via the interactive confirmation feature or the interactive rejection feature, and, in an absence of the input from the operator and to the extent permitted, to execute a next step of the pre-defined sequence of machine actions after the pre-determined time period.

### BRIEF DESCRIPTION OF THE DRAWINGS

The present invention is described in greater detail below on the basis of embodiments and of the drawings in which:

FIG. 1 is a perspective view of a drilling unit;

FIG. 2 illustrates machines forming part of a drilling plant;

FIG. 3 illustrate machines forming part of a drilling plant;

FIG. 4 shows an example of a drilling plant;

FIG. 5 shows an example of a drilling plant;

FIG. 6 shows an example of a driller's cabin;

FIG. 7 illustrates a controller with a sequence operator and their interconnection with other parts of a drilling plant;

FIG. 8 illustrates an operator interface; and

FIG. 9 illustrates an operator interface.

### DETAILED DESCRIPTION

In an example, there is provided a drilling plant comprising: a plurality of machines; an operator interface comprising a display interface; and a controller operatively connected to the plurality of machines and to the operator interface; the controller comprising a sequence operator operable to execute a pre-defined sequence of machine actions at the drilling plant; wherein the controller is configured to, during execution of the pre-defined sequence: present, via the display interface, an operational condition to be checked by an operator, present, via the operator interface, an interactive confirmation feature and an interactive rejection feature, wait a pre-determined time period for an input from the operator via the interactive confirmation feature or the interactive rejection feature, and in the absence of input, execute a next step of the pre-defined sequence after the pre-determined time period.

In an example, there is provided a method of operating a drilling plant, the method comprising operating a controller comprising a sequence operator to execute a pre-defined sequence of machine actions at the drilling plant, wherein operating the controller comprises: presenting, via a display interface, an operational condition of the drilling plant to be checked by an operator, presenting, via an operator interface, an interactive confirmation feature and an interactive rejection feature, waiting a pre-determined time period for an input from the operator via the interactive confirmation feature or the interactive rejection feature, and in the absence of input, executing a next step of the pre-defined sequence after the pre-determined time period.

The detailed description below and the appended claims outline further inventive aspects and embodiments.

The above and other characteristics will become clear from the following description of illustrative, non-restrictive examples, with reference to the attached drawings.

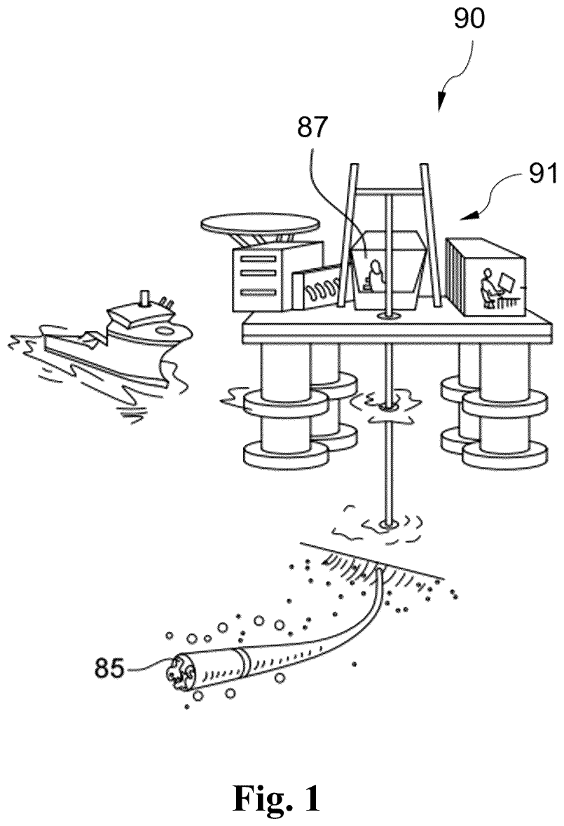

FIG. 1 shows a drilling unit 90, in this case a floating drilling unit. A drilling plant 91 is arranged on the drilling unit 90. The drilling plant typically comprises a rig structure and associated machinery for handling pipes, drilling fluid, and a drill string 85. A wellbore is created with the drill string 85 via the drilling plant 91. The wellbore, and consequently the drill string 85, may be many hundred meters long or more. A driller's cabin 87 is provided in conjunction with and as part of the drilling plant 91. Operators, such as a driller, monitor and control the drilling process from the driller's cabin 87.

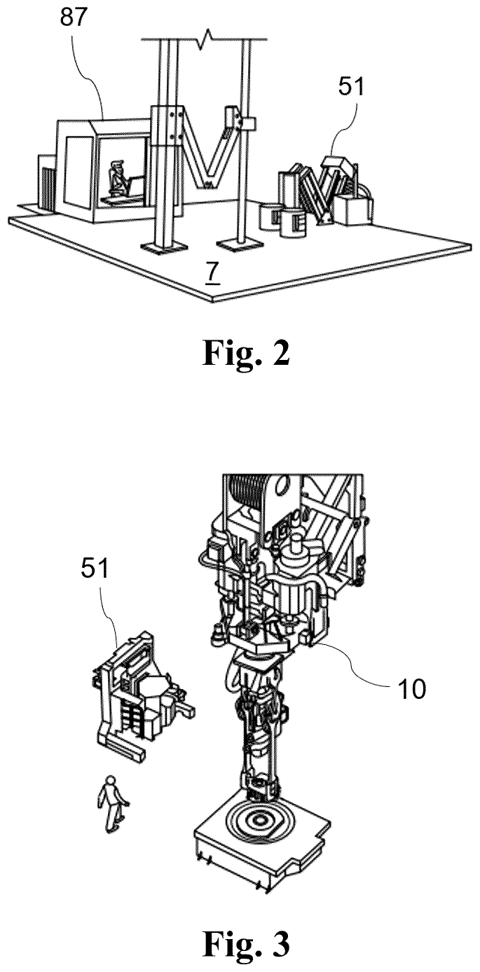

FIGS. 2 and 3 illustrate example machines forming part of the drilling plant 91. A power tong 51 is arranged for making up or breaking out pipe connections in the drill string 85, and a drilling machine 10 (e.g., a top drive) is used for carrying and rotating the drill string 85.

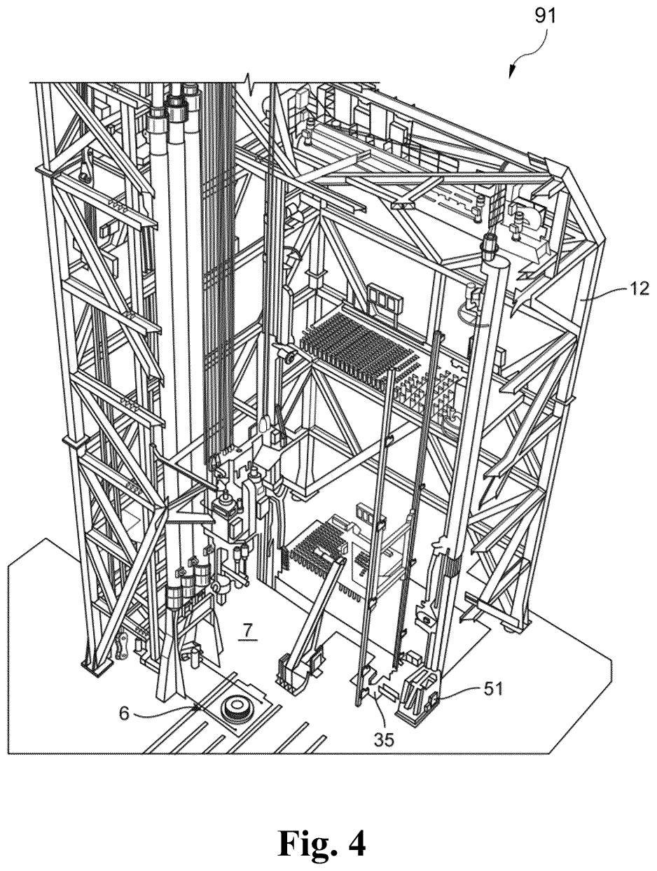

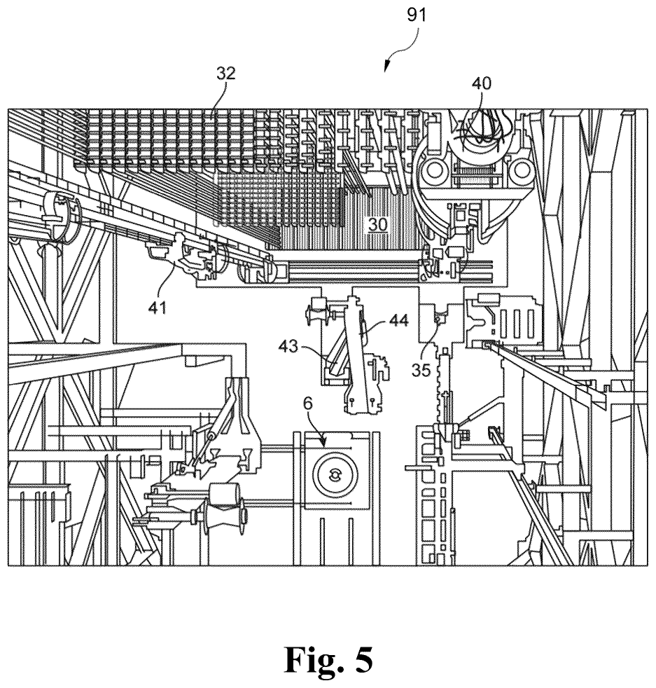

FIGS. 4 and 5 show examples of a drilling plant 91 with rig structure 12 arranged at a drill floor 7 having a well center opening 6, power tong 51, a mouse hole 35, fingerboard 32 arranged in conjunction with a setback 30, vertical pipe handling machines 40, 41, guiding arrangements 43, 44, etc. The general arrangement of such drilling plants will be familiar to the skilled reader; see, for example, the abovementioned WO 2021/006742 A1.

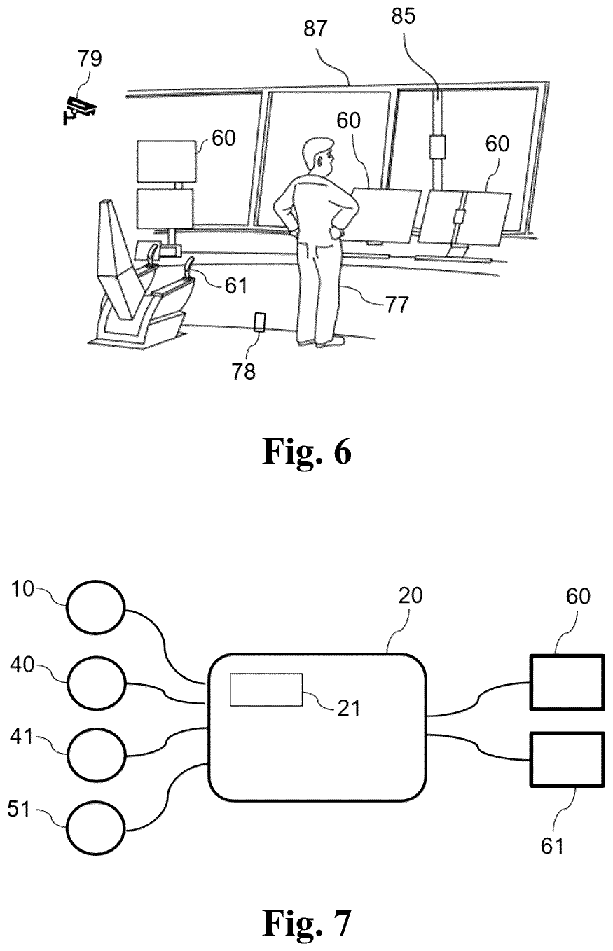

FIG. 6 shows an example of a driller's cabin 87. A drilling operator (e.g., a driller) 77 in the driller's cabin 87 monitors drilling operations at the drilling plant 91. Relevant operational information, for example, measurements from downhole or from the drilling plant 91 and/or the operational state of machines forming part of the drilling plant 91, is provided via display devices 60. Operator input to control or otherwise influence the drilling process can be provided via input device 61, e.g., a joystick, or via touchscreen etc.

In some cases, illustrated schematically in FIG. 7, the drilling plant 91 may comprise a controller 20, in this case a microprocessor-based electronic control unit, which is operatively connected to the plurality of machines 10, 40, 41, 51 and to the input device 61 and the display device(s) 60. The controller 20 can comprise a sequence operator 21, which may itself be an electronic control unit or an application running on the controller 20. The sequence operator 21 may have a plurality of pre-defined sequences stored therein (sometimes denoted “CADS sequences”) and be operable to automatically or semi-automatically execute those sequences by operation of the machines 10, 40, 41, 51, whereby the machines 10, 40, 41, 51 interact to carry out the sequence. The pre-defined sequence may in each case comprise a set/series of machine instructions for this purpose.

The sequences may, for example, be associated with tripping the drill string, building the drill string, drilling, or other operations to be carried out at the drilling plant 91. A sequence may cover a part of such an operation or the full operation. A sequence may also comprise several such operations executed consecutively. In many cases, the drilling plant 91 will be operated to carry out similar suboperations a large number of times, for example, to pick up a stand from the fingerboard 32/setback 30 by use of the pipe handling machines 40, 41, positioning the stand above the well center opening 6, bringing the stand into engagement with the drill string 85, connecting the stand to the drill string 85 via the power tong 51, and lowering the drill string 85 via a hoisting system and the drilling machine 10. Such repeated operations lend themselves to automation, however, for various reasons such as safety reasons, an operator 77 is required to control the operations as errors may have significant consequences.

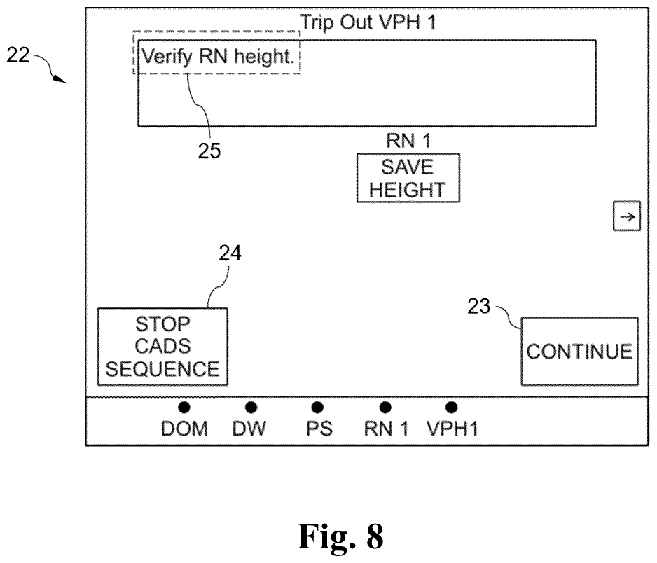

FIG. 8 illustrates an operator interface 22 presented to the operator 77 via the display device 60 during an automated sequence run by the sequence operator 21. During the automated sequence, the operator 77 is prompted from time to time with notifications 25 to confirm certain conditions before the automated process continues. This requires the operator 77 to perform an action, such as to activate a confirm button 23, for the automated sequence to continue. In the illustrated example, the sequence is a trip-out sequence and the operator 77 is prompted to visually check the height of the roughneck (RN), i.e., the power tong 51, relative to a stick-up of the drill string 85 at the well center opening 6. Such a visual check may be done directly, e.g., from a window in the driller's cabin 87, and/or via instruments or via operational displays (e.g., camera views) showing relevant information about the drilling plant 91. In this example, the operator 77 needs to confirm that the RN is at a correct height for the sequence to continue, and the operator 77 may then adjust the height if needed (for example, via the input device 61, such as a joystick). Manual adjustment is typically only occasionally required, but the operator still needs to press the confirm button 23 in all cases. In many cases, the operator 77 thus need not to perform any other actions other than to visually verify the condition and to provide feedback to the controller 20 to continue executing the sequence.

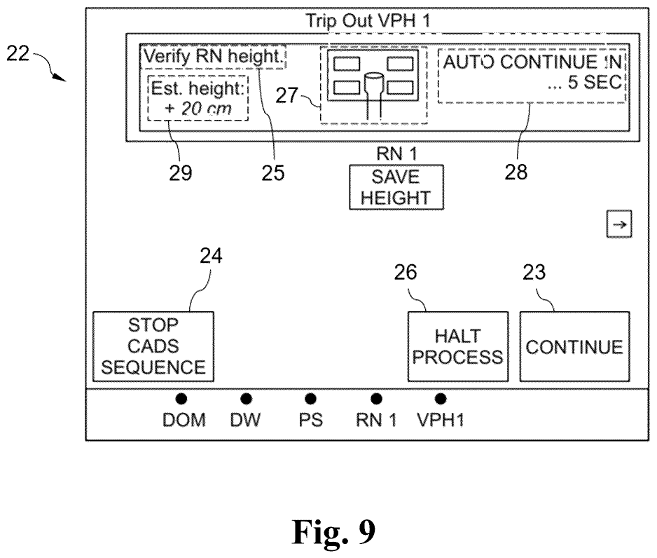

FIG. 9 illustrates an example where the drilling plant 95 has an operator interface 22 which may be provided at, or be integral with, the display device 60. The operator interface 22 may comprise the input device 61, for example, by arranging the operator interface 22 as a touchscreen. The display device 60 and input device 61 (see e.g., FIG. 6) may alternatively together form the operator interface 22.

The controller 20 is operatively connected to the plurality of machines 10, 40, 41, 51 and to the operator interface 22. The controller 20, with the sequence operator 21, is operable to execute a pre-defined sequence of machine actions at the drilling plant 95. Each sequence can comprise several steps, carried out by several machines, for example, carried out sequentially or carried out by several machines operating in cooperation.

During execution of the pre-defined sequence, the controller 20 is further configured to present a notification 25 of a condition to be checked by an operator 77 at the display device 60. The notification 25 may present the operator 77 with a case-by-case specific text describing the scenario and what to observe. This can be at a step in the sequence where it is required for the operator 77 to verify a certain condition before the sequence continues. The condition can typically be a machine state that is not possible or is difficult to detect accurately due to lack of instrumentation, unexpected behavior, or critical phases in the process. The condition may, for example, be to check and verify correct roughneck (RN) height, as illustrated in this example.

The controller 20 may be configured to present a graphic illustration 27 or animation indicative of or related to the condition to be checked by the operator 77. This may, for example, be a case specific graphical illustration in conjunction with a case specific text notification 25. This may assist the operator 77 in promptly identifying the case in a safe manner and the expectations of the operator.

The controller 20 may be configured to present an estimated value 29 for the condition. The estimated value 29 may, for example, be a system-estimated value based on sensor readings, operational states of equipment, or other known parameters. Estimated roughneck (RN) height relative to the stick-up may, for example, be estimated based on sensor readings, such as camera sensors at the drill floor 7. This may provide guidance to the operator 77 even it is known in some cases that such estimations may have inaccuracies associated therewith.

The controller 20 further presents an interactive confirmation feature 23 and an interactive rejection feature 24, 26. When executing the pre-defined sequence, the controller 20 is further configured to wait a pre-determined time period for input via the interactive confirmation feature 23 or the interactive rejection feature 24, 26, and in the absence of such input, execute the next step of the pre-defined sequence after the pre-determined time period. The pre-defined time period may, for example, be 5 seconds, 10 seconds or other values. The time period may in some cases correspond with a time which is any case required for activities in the sequence, such as a machine moving into position for the next step, i.e., so that the time period forms a “natural” pause. The execution of machine functions may in other cases be actively paused during the pre-determined time period to allow time for the operator 77 to check and verify the condition in question.

The time period may be adapted to correspond with (i.e., be somewhat longer than) the typical time it takes for the operator 77 to check the condition in question. The controller 20 may also be configured to present the pre-defined time period and/or a remaining time (e.g., a count-down) of the pre-defined time period 28 at the operator interface 22, as illustrated in FIG. 9.

The interactive rejection feature 24, 26 comprises a stop sequence function 24, whereby the controller 20 is configured, upon activation of the stop sequence function 24 by the operator 77, to stop the execution of the pre-defined sequence and to discard any remaining steps of the pre-defined sequence. Activating the stop sequence function 24 thus abandons the pre-defined sequence.

The interactive rejection feature 24, 26 also comprises a halt sequence function 26, whereby the controller 20 is configured, upon activation of the halt sequence function 26 by the operator 77, to temporarily stop the pre-defined sequence and, upon activation of the confirmation feature 23 by the operator 77, to continue executing the pre-defined sequence.

The operator 77 may thereby halt the sequence, for example, to perform a manual operation/correction/adjustment if required, or for other purposes. The fact that the operator 77 chose to halt the sequence in this manner via the halt sequence function 26 may be indicated at the operator interface 22, and the sequence will not continue until the operator 77 has approved continuation of the sequence via the confirmation feature 23. A notification indicating that the sequence is halted can, for example, be displayed in place of the remaining time of the pre-defined time period 28 if halt is activated.

The stop sequence function 24, halt sequence function 26, and confirmation feature 23 may be push buttons on a touch screen interface, be functions which can be activated by another input device 61 (such as a joystick), or be selectively activatable by the operator 77 in other ways. The controller 20 can optionally be configured so that any movement of the input device 61, such as a joystick, during the pre-determined time period will activate the halt sequence function 26. This may assist the operator 77 to quickly take action if deemed necessary. Such a configuration may optionally also shorten the pre-determined time.

The controller 20 may be configured so that an activation of the confirmation feature 23 by the operator 77 during the pre-determined time period immediately executes the next step in the sequence, without waiting for the expiry of the pre-determined time period. The operator 77 may at any time thereby activate the confirmation feature 23 to continue the sequence without further delay.

In some examples, the controller 20 may, for one or more steps in the sequence, receive or calculate an estimated value 29 for the condition to be checked by the operator 77 and use the estimation as a condition for whether automatic execution of the step in question should be permitted. The controller 20 may for this purpose evaluate whether the condition lies within a pre-determined range of expected values for the condition, and (i) if the condition lies outside the pre-determined range, require active input from the operator 77 via the confirmation feature 23 for executing the step in question, and (ii) if the condition lies within the pre-determined range, execute the next step of the pre-defined sequence after the pre-determined time period. In this manner, if, for example, sensor readings or data validation at the drilling plant 95 suggests that a condition is outside an expected range, the automatic execution of sequence steps will not be carried out, but the system will require a check and verification by the operator 77. In the illustrated example, if, for example, the estimated value 29 (such as the RN/stickup height or its offset from a target value) lies within a range which would not be expected to disturb the machine function(s) in the next step, automatic execution is permitted, whereas if the height or offset is outside this range, then a forced check/verification (and optionally an adjustment) by the operator 77 is effectuated by requiring active confirmation from the operator 77.

The controller 20 may be configured to receive a state indicator from at least one of the plurality of machines 10, 40, 41, 51, and to automatically (i.e., in the absence of input from the operator 77) execute the next step of the pre-defined sequence only if the state indicator meets a pre-defined condition. The state indicator may, for example, be a position of a relevant machine, confirmation that a functionality of the machine is operable, that the machine is in the correct state to carry out the machine function in question, etc. The controller 20 may, for example, require that the state indicator lies within a pre-defined range or be above or below a pre-defined threshold, or that a “ready” signal is provided by the machine(s) in question. An automatic continuation of the sequence is thereby prohibited, and an active confirmation by the operator 77 is required, in case the system detects an incorrect or unexpected machine state. Examples of an unexpected machine state include a “machine alarm” event due to loss of power, machine functions being unavailable, instrumentation errors, incorrect positioning, etc., which could lead to the next step in the sequence not being carried out correctly.

The pre-defined sequence may comprise a plurality of steps, wherein each step is associated with specific step conditions which are evaluated by the controller 20. This may include a condition as to whether automatic execution shall be permitted for the step in question (or alternatively, if a positive confirmation by the operator 77 is required for the step), an individual setting for the pre-determined time period for the step, the type of notification presented at the display device 60 for the step, or other conditions.

Via the step condition information, at least one first step in the sequence may, for example, be provided so that automatic execution is permitted and that the controller 20, in the absence of input from the operator 77, automatically executes the first step after the pre-determined time period. A second step of the sequence may, via the step condition information, be configured so that automatic execution is not permitted so that the controller 20 executes the second step only upon activation of the confirmation feature 23 by an operator 77. Individual conditions can thereby be provided to different steps in the sequence.

In some examples, the drilling plant 95 may comprise an operator sensor 79 which is operatively arranged to sense a presence and/or a state of the operator 77 adjacent the operator interface 22, 60, 61. FIG. 6 shows that the operator sensor 79 may, for example, be a camera, an infrared camera/detector, a motion sensor, a sensor in the seat of a driller's chair, a dead-man's switch, or the like. This may allow the operator sensor 79 to detect whether the operator 77 is present adjacent (i.e., within operational reach of) the operator interface 22, 60, 61 and/or whether the operator 77 has an appropriate attention directed to the drilling process. The operator sensor 79 may advantageously be positioned in the driller's cabin 87 for this purpose.

The operator sensor 79 provides a signal representative of the presence and/or state of the operator 77 to the controller 20. The controller 20 can be configured to (i) evaluate whether the signal meets pre-determined criteria for operator presence and/or state, and (ii) if the signal does not meet the predetermined criteria, halt execution of the sequence and require an active input via the confirmation feature 23 for executing the next step of the pre-defined sequence.

The automatic execution of the sequence can thereby be halted if the operator 77 is not present or their position, attention state, etc. does not meet pre-determined criteria. The pre-determined criteria may, in a basic example, simply be that the operator 77 must be present in a certain area of the driller's cabin 87, or that the operator 77 is observed to move regularly so as to indicate that the operator 77 is actively monitoring the drilling process. The signal and/or the evaluation may be binary, for example, in the form of either “operator present”/“operator state acceptable” or “operator not present”/“operator state not acceptable”. The operator sensor 79 may optionally comprise more advanced functionality, for example, predictions of operator fatigue or tiredness via eye movement readings or the like. A pre-determined criteria may thereby comprise meeting thresholds for awareness on the part of the operator 77, whereby the automatic execution of the sequence can be halted if the operator 77 is predicted to be tired, fatigued, or otherwise having impaired awareness.

In some examples, the drilling plant 95 may comprise an operator confirmation device 78 as illustrated schematically in FIG. 6. The operator confirmation device 78 may, for example, be a pushbutton, pedal, proximity sensor, or the like, which the operator 77 can activate, for example, by foot or by hand. It may be arranged at a drilling chair, on the floor, or elsewhere adjacent the operator interface 22, 60, 61. The operator confirmation device 78 is arranged to provide regular signals representative of the presence and/or state of the operator 77, via the operator 77 having activated the operator confirmation device 78, to the controller 20. The operator confirmation device 78 may optionally be integral with an operator sensor 79, for example, so that movement of the operator 77 in a particular area adjacent the operator interface 22, 60, 61 is registered as a presence signal. In any of the embodiments described herein, the operator confirmation device 78 may be a dead man's switch, i.e., a switch that is designed to be activated or deactivated if the operator 77 becomes incapacitated, such as through loss of consciousness or being bodily removed from control.

The controller 20 is in turn configured to: (i) evaluate a time lapsed since a signal representative of the presence of the operator 77 was received, and (ii) if the time lapsed exceeds a predetermined threshold, to halt execution of the sequence and require active input via the confirmation feature 23 for executing the next step of the pre-defined sequence. The time may, for example, be 3 minutes, 5 minutes, 10 minutes, or other values. The time may be chosen and varied depending on the type of operation carried out; a shorter time can typically be chosen for operations involving higher risk.

The presence of the operator 77 can thereby be provided through regular manual confirmation, and in an event where the operator 77 fails to provide feedback via the operator confirmation device 78 that he/she is present adjacent the operator interface 22, 60, 61 and monitoring the operation, automatic execution of steps in the sequence will be halted or stopped. This reduces the risk of the automatic execution of steps without the operator 77 being present or actively monitoring the operation, for example, in an event that the operator 77 is distracted or (for whatever reason) leaves the driller's cabin 87 or the operator interface 22, 60, 61 without halting or stopping the automatic sequence.

According to examples described herein, an automated sequence at a drilling plant 95 can be executed without a requirement that the operator 77 perform any active confirmation action for some or all steps of the sequence unless required to do a fault correction, such as to move machines 10, 40, 41, 51 or change parameters, or in the case of an unexpected situation, such as a safety concern. The operator 77 is given the opportunity to halt the process and perform manual correction if needed, and if no such action is taken, the sequence will continue automatically for one or more steps in the sequence.

In any of the examples described here, the operator can be notified with visual, audio and/or other methods. For example, a notification sound, a pop-up, or other visual changes at the display device 60, vibrations and/or other form for indications can be used to draw the operator's attention.

According to examples described herein, operation of a drilling plant 95 more efficiently and/or with safety benefits can be achieved, for example, thereby reducing the demands on an operator 77 by partially automating operations while maintaining safety standards, for example, in case of unexpected events.

The following numbered clauses outline further inventive aspects and embodiments:

Clause 1: A drilling plant (95) comprising:
a plurality of machines (10, 40, 41, 51);
an operator interface (22, 60, 61) comprising a display interface (60); and
a controller (20) operatively connected to the plurality of machines (10, 40, 41, 51) and to the operator interface (22, 60, 61);
the controller (20) comprising a sequence operator (21) operable to execute a pre-defined sequence of machine actions at the drilling plant (95);
wherein the controller (20) is configured to, during execution of the pre-defined sequence:
   present, via the display device (60), an operational condition to be checked by an operator (77),
   present, via the operator interface (22, 60, 61), an interactive confirmation feature (23) and an interactive rejection feature (24, 26),
   wait a pre-determined time period for an input from the operator (77) via the interactive confirmation feature (23) or the interactive rejection feature (24, 26), and
   in the absence of input, execute a next step of the pre-defined sequence after the pre-determined time period.

Clause 2: The drilling plant according to any preceding clause, wherein the controller (20) is configured to present, along with the condition to be checked by the operator (77), an estimated value (29) for the condition.

Clause 3: The drilling plant according to any preceding clause, wherein the controller (20) is configured to present, along with the condition to be checked by the operator (77), a graphic illustration (27) or animation indicative of the condition to be checked by the operator (77).

Clause 4: The drilling plant according to any preceding clause, wherein the controller (20) is configured to issue a notification, such as an audible notification, along with the condition to be checked by the operator (77).

Clause 5: The drilling plant according to any preceding clause, wherein the controller (20) is configured to present, along with the condition to be checked by the operator (77), the pre-defined time period and/or a remaining time of the pre-defined time period (28).

Clause 6: The drilling plant according to any preceding clause, wherein the controller (20) is configured to receive a state indicator from at least one of the plurality of machines (10, 40, 41, 51), and to (i) evaluate whether the state indicator meets a pre-defined condition, and (ii) in the absence of input from the operator (77), execute the next step of the pre-defined sequence after the pre-determined time period only if the state indicator meets the pre-defined condition.

Clause 7: The drilling plant according to any preceding clause, wherein the interactive rejection feature (24, 26) comprises:
a stop sequence function (24), whereby the controller (20) is configured, upon activation of the stop sequence function (24) by the operator (77), to stop the execution of the pre-defined sequence and discard any remaining steps of the pre-defined sequence, and
a halt sequence function (26), whereby the controller (20) is configured, upon activation of the halt sequence function (26) by the operator (77), to temporarily stop the pre-defined sequence and, upon activation of the confirmation feature (23) by the operator (77), to continue executing the pre-defined sequence.

Clause 8: The drilling plant according to any preceding clause, wherein the pre-defined sequence comprises:
at least one first step for which automatic execution is permitted and the controller (20) is configured to, in the absence of input from the operator (77), execute the first step of the pre-defined sequence after the pre-determined time period, and
at least one second step for which automatic execution is not permitted, and the controller (20) is configured to execute the at least one second step only upon activation of the confirmation feature (23) by the operator (77).

Clause 9: The drilling plant according to any preceding clause, wherein the operator interface (22, 60, 61) comprises an input device (61), such as a joystick, and the controller (20) is configured such that any action by the operator (77) on the input device (61), such as movement of the joystick, during the pre-determined time activates the halt sequence function (26).

Clause 10: The drilling plant according to any preceding clause, wherein the controller (20) is configured to, upon activation of the confirmation feature (23) by the operator (77) during the pre-determined time period, execute the next step of the pre-defined sequence immediately and before expiry of the pre-determined time period.

Clause 11: The drilling plant according to any preceding clause, wherein
the pre-defined sequence comprises a plurality of steps, and wherein each step is associated with step conditions, and
the controller (20) is configured to evaluate the step conditions for each step during execution of the pre-defined sequence.

Clause 12: The drilling plant according to any preceding clause, wherein the step conditions comprise at least one of:
instructions to require active input via the confirmation feature (23) for executing the step in question,
an individual setting for the pre-determined time period for the step in question, or
a type of notification to be presented at the display device (60) for the step in question.

Clause 13: The drilling plant according to any preceding clause, wherein the controller (20) is configured to, for at least one step in the sequence:
receive or calculate an estimated value (29) for the condition to be checked by the operator (77),
evaluate whether the estimated value (29) lies within a pre-determined range of acceptable values for the condition, and
(i) if the estimated value (29) lies outside the pre-determined range, require active input via the confirmation feature (23) for executing the step in question, and
(ii) if the estimated value (29) lies within the pre-determined range, execute the next step of the pre-defined sequence after the pre-determined time period.

Clause 14: The drilling plant according to any preceding clause, the plant comprising an operator sensor (79) operatively arranged to sense a presence and/or a state of the operator (77) adjacent the operator interface (22, 60, 61) and provide a signal representative of the presence and/or state of the operator (77) to the controller (20), and wherein the controller (20) is configured to:
(i) evaluate whether the signal meets a pre-determined criterion for operator presence and/or state, and (
ii) if the signal does not meet the predetermined criteria, halt execution of the sequence and require active input via the confirmation feature (23) for executing the next step of the pre-defined sequence.

Clause 15: The drilling plant according to any preceding clause, the plant comprising an operator confirmation device (78) operatively arranged to receive regular presence input from the operator (77) and to provide regular signals representative of the presence of the operator (77) to the controller (20),
wherein the controller (20) is configured to:
(i) evaluate a time lapsed since a signal representative of the presence of the operator (77) was received, and
(ii) if the time lapsed exceeds a predetermined threshold, halt execution of the sequence and require active input via the confirmation feature (23) for executing the next step of the pre-defined sequence.

Clause 16: A method of operating a drilling plant (95), the method comprising operating a controller (20) comprising a sequence operator (21) to execute a pre-defined sequence of machine actions at the drilling plant (95), wherein operating the controller (20) comprises:
presenting, via a display device (60), an operational condition of the drilling plant (95) to be checked by an operator (77),
presenting, via an operator interface (22, 60, 61), an interactive confirmation feature (23) and an interactive rejection feature (24, 26),
waiting a pre-determined time period for an input from the operator (77) via the interactive confirmation feature (23) or the interactive rejection feature (24, 26), and
in the absence of input, executing a next step of the pre-defined sequence after the pre-determined time period.

Clause 17: The method according to any preceding clause, comprising operating the controller (20) to present, along with the condition to be checked by the operator (77), an estimated value (29) for the condition.

Clause 18: The method according to any preceding clause, comprising operating the controller (20) to present, along with the condition to be checked by the operator (77), a graphic illustration (27) or animation indicative of the condition to be checked by the operator (77).

Clause 19: The method according to any preceding clause, comprising operating the controller (20) to issue a notification, such as an audible notification, along with the condition to be checked by the operator (77). Clause 20: The method according to any preceding clause, comprising operating the controller (20) to present, along with the condition to be checked by the operator (77), the pre-defined time period and/or a remaining time of the pre-defined time period (28).

Clause 21: The method according to any preceding clause, comprising operating the controller (20) to receive a state indicator from at least one of a plurality of machines (10, 40, 41, 51) of the drilling plant (95), and to (i) evaluate whether the state indicator meets a pre-defined condition, and (ii) in the absence of input from the operator (77), execute the next step of the pre-defined sequence after the pre-determined time period only if the state indicator meets the pre-defined condition.

Clause 22: The method according to any preceding clause, comprising:
receiving, at the controller (20), an activation of a stop sequence function (24) by the operator (77), and
operating the controller (20) to stop the execution of the pre-defined sequence and discard any remaining steps of the pre-defined sequence.

Clause 23: The method according to any preceding clause, comprising:
receiving, at the controller (20), an activation of a halt sequence function (26) by the operator (77), and
operating the controller (20) to temporarily stop the pre-defined sequence and, upon activation of the confirmation feature (23) by the operator (77), to continue executing the pre-defined sequence.

Clause 24: The method according to any preceding clause, comprising operating the controller (20) to, upon activation of the confirmation feature (23) by the operator (77) during the pre-determined time period, execute the next step of the pre-defined sequence immediately and before expiry of the pre-determined time period.

Clause 25: The method according to any preceding clause, comprising receiving, at the controller (20), step conditions associated with each of a plurality of steps in the sequence, and
operating the controller (20) to evaluate the step conditions for each step during execution of the pre-defined sequence.

Clause 26: The method according to any preceding clause, wherein the step conditions comprise at least one of:
instructions to require active input via the confirmation feature (23) for executing the step in question,
an individual setting for the pre-determined time period for the step in question, or
a type of notification to be presented at the display device (60) for the step in question,
and the method comprises executing the step in question according to the step conditions.

Clause 27: The method according to any preceding clause, comprising operating the controller (20) to, for at least one step in the sequence:
receive or calculate an estimated value (29) for the condition to be checked by the operator (77),
evaluate whether the estimated value (29) lies within a pre-determined range of acceptable values for the condition, and
(i) if the estimated value (29) lies outside the pre-determined range, require active input via the confirmation feature (23) for executing the step in question, and
(ii) if the estimated value (29) lies within the pre-determined range, execute the next step of the pre-defined sequence after the pre-determined time period.

Clause 28: The method according to any preceding clause, comprising operating an operator sensor (79) to sense a presence and/or a state of the operator (77) adjacent the operator interface (22, 60, 61) and provide a signal representative of the presence and/or state of the operator (77) to the controller (20), and
operating the controller (20) to:
(i) evaluate whether the signal meets a pre-determined criterion for operator presence and/or state, and
(ii) if the signal does not meet the predetermined criteria, halt execution of the sequence and require active input via the confirmation feature (23) for executing the next step of the pre-defined sequence.

Clause 29: The method according to any preceding clause, comprising operating an operator confirmation device (78) to receive regular presence input from the operator (77) and to provide regular signals representative of the presence of the operator (77) to the controller (20), and
operating the controller (20) to:
(i) evaluate a time lapsed since a signal representative of the presence of the operator (77) was received, and
(ii) if the time lapsed exceeds a predetermined threshold, halt execution of the sequence and require active input via the confirmation feature (23) for executing the next step of the pre-defined sequence.

Clause 30: A control system for a drilling plant (95), the control system comprising a controller (20) with a sequence operator (21) having at least one pre-defined sequence of machine actions stored therein, which when executed by the controller (20) causes the control system to carry out the method of any one of the preceding clauses.

The invention is not limited by the embodiments described above; reference should be had to the appended claims.

### LIST OF REFERENCE NUMERALS

6 Well center opening
7 Drill floor
10 Drilling machine
12 Rig structure
20 Controller
21 Sequence operator
22 Operator interface
23 Confirm button/Confirmation feature
24 Stop sequence feature/Interactive rejection feature
25 Notification
26 Halt sequence function/Interactive rejection feature
27 Graphic illustration
28 Pre-defined time period
29 Estimated value
30 Setback
32 Fingerboard
35 Mouse hole
40 Vertical pipe handling machine
41 Vertical pipe handling machine
43 Guiding arrangement
44 Guiding arrangement
51 Power tong
60 Display device
61 Input device
77 Operator
78 Operator confirmation device
79 Operator sensor
85 Drill string
87 Driller's cabin
90 Drilling unit
91 Drilling plant

What is claimed is:

1-15. (canceled)

16. A drilling plant comprising:
a plurality of machines;
an operator interface comprising a display device; and
a controller which is operatively connected to the plurality of machines and to the operator interface, the controller comprising a sequence operator which is configured to execute a pre-defined sequence of machine actions at the drilling plant, the controller being configured, during the execution of the pre-defined sequence of machine actions,
to present, via the display device, an operational condition to be checked by an operator,
to present, via the operator interface, an interactive confirmation feature and an interactive rejection feature,
to wait a pre-determined time period for an input from the operator via the interactive confirmation feature or the interactive rejection feature, and
in an absence of the input from the operator and to the extent permitted, to execute a next step of the pre-defined sequence of machine actions after the pre-determined time period.

17. The drilling plant as recited in claim 16, wherein the controller is further configured to present, along with the operational condition to be checked by the operator, an estimated value for the operational condition.

18. The drilling plant as recited in claim 16, wherein the controller is further configured to present, along with the operational condition to be checked by the operator, a graphic illustration and/or an animation which is indicative of the operational condition to be checked by the operator.

19. The drilling plant as recited in claim 16, wherein the controller is further configured to issue a notification together with the operational condition to be checked by the operator.

20. The drilling plant as recited in claim 19, wherein the notification is an audible notification.

21. The drilling plant as recited in claim 16, wherein the controller is further configured to present, along with the operational condition to be checked by the operator, the pre-determined time period and/or a remaining time of the pre-determined time period.

22. The drilling plant as recited in claim 16, wherein the controller is further configured,
to receive a state indicator from at least one of the plurality of machines,
to evaluate whether the state indicator meets a pre-defined condition, and
in the absence of the input from the operator, to execute the next step of the pre-defined sequence of machine actions after the pre-determined time period only if the state indicator meets the pre-defined condition.

23. The drilling plant as recited in claim 16, wherein the interactive rejection feature comprises:
a stop sequence function, wherein the controller is further configured, upon activation of the stop sequence function by the operator, to stop the execution of the pre-defined sequence of machine actions and to discard any remaining steps of the pre-defined sequence of machine actions; and
a halt sequence function, wherein the controller is further configured, upon activation of the halt sequence function by the operator, to temporarily stop the pre-defined sequence of machine actions and, upon activation of the interactive confirmation feature by the operator, to continue executing the pre-defined sequence of machine steps.

24. The drilling plant as recited in claim 23, wherein,
the operator interface further comprises an input device, and
the controller is further configured so that an action by the operator on the input device during the pre-determined time period activates the halt sequence function.

25. The drilling plant as recited in claim 24, wherein the input device is a joystick, and the action by the operator on the input device is a movement of the joystick.

26. The drilling plant as recited in claim 16, wherein the pre-defined sequence of machine steps comprises:
at least one first step for which an automatic execution is permitted and the controller is further configured, in the absence of the input from the operator, to execute the first step of the pre-defined sequence of machine steps as the next step after the pre-determined time period; and
at least one second step for which the automatic execution is not permitted, and the controller is further configured to execute the at least one second step as the next step only upon activation of the interactive confirmation feature by the operator.

27. The drilling plant as recited in claim 16, wherein the controller is further configured, upon activation of the interactive confirmation feature by the operator during the pre-determined time period, to execute the next step of the pre-defined sequence of machine steps immediately and prior to an expiry of the pre-determined time period.

28. The drilling plant as recite din claim 16, wherein,
the pre-defined sequence of machine steps comprises a plurality of steps,
each step of the plurality of steps is associated with step conditions, and
the controller is further configured to evaluate the step conditions for each of the plurality of steps during the execution of the pre-defined sequence of machine steps.

29. The drilling plant as recited in claim 28, wherein the step conditions comprise at least one of,
instructions to require an active input via the interactive confirmation feature for executing a relevant step of the plurality of steps,
an individual setting for the pre-determined time period for the relevant step of the plurality of steps, and
a type of notification to be presented at the display device for the relevant step of the plurality of steps.

30. The drilling plant as recited in claim 28, wherein the controller is further configured, for at least one step of the plurality of steps of the pre-defined sequence of machine actions,
to receive or to calculate an estimated value for the operational condition to be checked by the operator,
to evaluate whether the estimated value lies within a pre-determined range of acceptable values for the operational condition, and
if the estimated value lies outside the pre-determined range of acceptable values for the operational condition, require an active input via the interactive confirmation feature for executing a relevant step of the plurality of steps, and
if the estimated value lies within the pre-determined range of acceptable values for the operational condition, execute the next step of the pre-defined sequence of machine steps after the pre-determined time period.

31. The drilling plant as recited in claim 28, further comprising:
an operator sensor which is operatively arranged to sense a presence and/or a state of the operator adjacent to the operator interface and to provide a signal which is representative of the presence and/or the state of the operator to the controller, wherein,
the controller is further configured,
to evaluate whether the signal meets a pre-determined criterion for the presence and/or the state of the operator, and
if the signal does not meet the predetermined criterion for the presence and/or the state of the operator, to halt the execution of the pre-defined sequence of machine actions and to require an active input by the operator via the interactive confirmation feature for executing a relevant next step of the plurality of steps of the pre-defined sequence of machine actions.

32. The drilling plant as recited in claim 28, further comprising:
an operator confirmation device which is operatively arranged to receive regular presence input from the operator and to provide regular signals which are representative of a presence of the operator to the controller, wherein,
the controller is further configured:
to evaluate a time lapsed since a signal which is representative of the presence of the operator was received, and
if the time lapsed exceeds a predetermined threshold, to halt the execution of the pre-defined sequence of machine actions and to require an active input via the interactive confirmation feature for executing a relevant next step of the plurality of steps of the pre-defined sequence of machine actions.
